(19) United States
(12) Patent Application Publication
(10) Pub. No.: US 2010/0091094 A1
(43) Pub. Date: Apr. 15, 2010

(54) Mechanism for Directing a Three-Dimensional Camera System

(76) Inventor: Marek Sekowski, Carlsbad, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/476,227

(22) Filed: Jun. 1, 2009

Related U.S. Application Data
(60) Provisional application No. 61/105,391, filed on Oct. 14, 2008.

(51) Int. Cl. H04N 13/02

(52) U.S. Cl. 348/50; 348/E13.074

(57) ABSTRACT

A mechanism for directing a three dimensional (3-D) camera is provided. The mechanism has a base that connects to a directable structure, to which the 3-D camera is attached. A control system accurately and precisely moves and positions the directable structure. The directable structure may be positioned in coarse movements to enable the 3-D camera to have an expanded field of view. More particularly, the desired field of view is divided into portions, and the directable structure moves the 3-D camera to be directed at each portion sequentially. Also, for each field of view portion, the directable structure positions the 3-D camera for acquiring a set of images, with each image being only slightly offset for the others. Using a dithering process, an enhanced effective resolution is obtained that exceeds the native resolution of the 3-D camera.

### CROSS REFERENCE TO RELATED APPLICATIONS

This application is related to U.S. application number 61/105,391, filed Oct. 14, 2008, and entitled “Forklift for Managing Freight and Method of Using Same,” which is incorporated by reference.

### BACKGROUND

The field of the present invention is mechanical devices for directing an imaging system. More specifically, the present invention relates to a gimbal-like mechanism directing a 3-D camera system. In one example, the present invention may be used for accurately determining a volume of freight using a lower-resolution 3-D camera system.

In the transportation field, most long-haul freight is handled using trucks, ships, airplanes, and trains. Long distance transportation typically starts with a company palletizing or otherwise preparing a shipment. Most often, the shipment is prepared in a way that facilitates its movement by a forklift or other mechanized machine. In this way, the palletized shipment is efficiently moved between the various carriers involved in moving the palletized shipment to its destination. In order to make the shipping industry efficient, shipping companies rely on assuring that every load is fully loaded, and that customers are accurately but fully billed for shipping services. Accordingly, it is highly desirable that any cargo container be fully loaded prior to departing to its next point. Although weight plays a part, loading a cargo container is mostly a volumetrically-limited process. For example, unless a truck is caring particularly heavy material such as iron bars or concrete, the limiting factor in how much cargo it can carry is the volume that the packages or palletized loads consume. This is particularly true in volume limited transportation modes, such as airline cargo. Airline cargo tends to carry lighter and bulkier freight, so an cargo airplane's loading capacity is typically limited by the volume it can carry, not the weight of the cargo.

In the past, most shipping charges were based on the weight of the freight. Weight is easy, accurate, and fast to measure, and can even be measured by scales integrated into freight moving devices. Also, weight is accurately determined, and can be verified by the shipper, the carrier, and the company receiving the freight. However, the shipping industry is moving towards more volume-based loading and billing. Since volume is relatively difficult to measure, shippers that load by volume have been able to assign volumes to a freight load, with little risk of challenge from the shipper or receiver. Such overbilling may be advantageous to the shipper in the short-term, but such inaccuracies also detrimentally affect their ability to efficiently load cargo containers.

Over the past few years, stationary volumetric systems have become available. Typically, these stationary volumetric systems have a scanning device mounted in a central location of a freight warehouse. Each time a volumetric measurement is needed, a forklift moves a palette from a first location to the central scanning location, and triggers a volumetric measurement. The forklift operator then picks up the freight load and moves it to its final destination. Unfortunately, such a centralized system is expensive to install in a warehouse, requires complicated laser scanning imagers, and often fails to accurately measure the freight. Due to the difficulty and expense in managing such a central volume scanning station, freight forwarders and freight managers typically use their central volume-based systems for only the most critical and valuable loads.

Therefore, there exists a need for a freight management system that enables the efficient and accurate measurement of freight volume. Further, it would be desirable that the freight management system will not require substantial changes or interference to the existing freight management infrastructure.

### SUMMARY

Briefly, the present invention provides a mechanism for directing a three dimensional (3-D) camera. The mechanism has a base that connects to a directable structure, to which the 3-D camera is attached. A control system accurately and precisely moves and positions the directable structure. The directable structure may be positioned in coarse movements to enable the 3-D camera to have an expanded field of view. More particularly, the desired field of view is divided into portions, and the directable structure moves the 3-D camera to be directed at each portion sequentially. Also, for each field of view portion, the directable structure positions the 3-D camera for acquiring a set of images, with each image being only slightly offset for the others. Using a dithering process, an enhanced effective resolution is obtained that exceeds the native resolution of the 3-D camera.

In one example, the directable mechanism is useful for determining the volume of a target freight. The mechanism may be constructed for mounting to a ceiling, for example, that is about 15 feet above where the freight is set. A pair of direct-drive motors and a motor controller cooperate as a two-axis gimbal, to which the 3-D camera is attached. Since the freight area is too large to be acquired in one image, the freight area is divided into two or more view-portions, and the gimbal is able to make larger-scale movements to sequentially direct the 3-D camera toward each portion. When directed to each portion, the gimbal makes smaller-scale movements that enable a set of images to be taken, where each image is only slightly offset from the other(s). An on-board computer uses these images to first apply a dithering process to enhance the native resolution of the 3-D camera, and then to use the enhanced data to calculate the volume of the target freight.

Advantageously, the disclosed system enables a single 3-D camera to acquire images over an expanded field of view area, avoiding the expense, complexity, and calibration issues associated with multi-camera systems. The same directing mechanism also provides for smaller scale fine movements that enable a set of images to be taken that can be processed using a dither algorithm. In this way, the effective resolution of the 3-D camera is enhanced, allowing a relatively low-resolution camera to provide data sufficiently accurate for determining freight volume.

### BRIEF DESCRIPTION OF THE DRAWINGS

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views. It will also be understood that certain components and details may not appear in the figures to assist in more clearly describing the invention.

FIG. 1 is an illustration of a mechanism for directing a three-dimensional camera system in accordance with the present invention.

FIG. 2 is a functional block diagram of a mechanism for directing a three-dimensional camera system in accordance with the present invention.

FIG. 3 is an illustration of a mechanism for directing a three-dimensional camera system in accordance with the present invention.

FIG. 4 is a top view of the system shown in FIG. 3.

FIG. 5a is an illustration of a how a mechanism for direction a three-dimensional camera may move to enable enhanced resolution.

FIG. 5b is an illustration of a how a mechanism for direction a three-dimensional camera may move to enable enhanced resolution.

FIG. 6 is a functional block diagram of a mechanism for directing a three-dimensional camera system in accordance with the present invention.

FIG. 7a is a functional block diagram of a mechanism for directing a three-dimensional camera system in accordance with the present invention.

FIG. 7b is a functional block diagram of a mechanism for directing a three-dimensional camera system in accordance with the present invention.

FIG. 8 is a functional block diagram of a mechanism for directing a three-dimensional camera system in accordance with the present invention.

FIG. 9 is a functional block diagram of a mechanism for directing a three-dimensional camera system in accordance with the present invention.

FIG. 10 is a flowchart for a volumetric-measuring system having a mechanism for directing a three-dimensional camera system.

FIG. 11 is a flowchart for a freight handling system having a mechanism for directing a three-dimensional camera system.

FIG. 12 is an illustration of a mechanism for directing a three-dimensional camera system in accordance with the present invention.

FIG. 13 is an exploded view of a mechanism for directing a three-dimensional camera system in accordance with the present invention.

### DETAILED DESCRIPTION

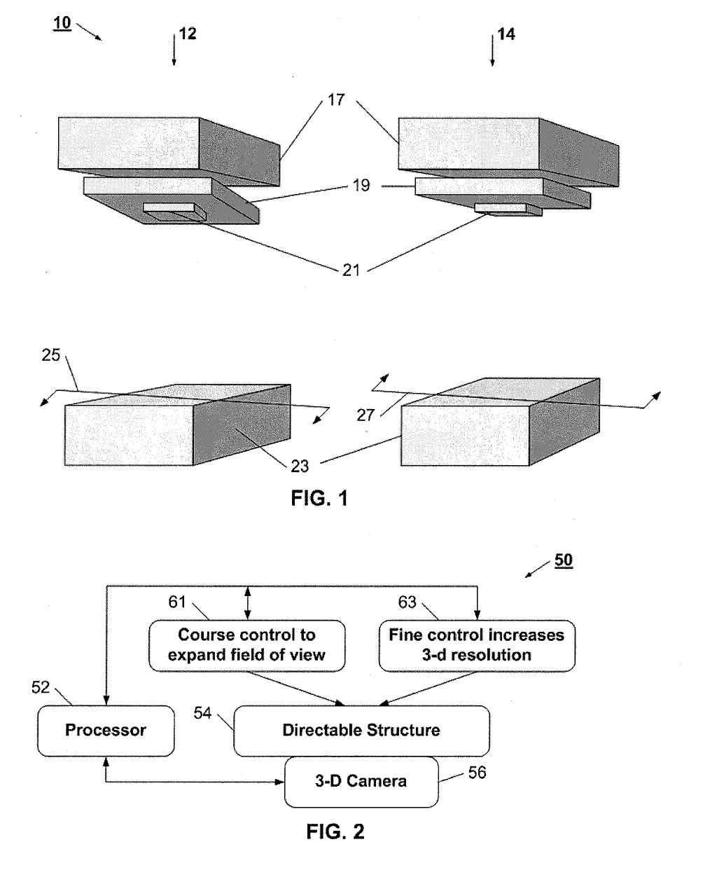

Referring now to FIG. 1, a mechanism for directing a three-dimensional camera system is illustrated. Mechanism 10 may be used to efficiently and accurately direct a three-dimensional camera at a target 23. In this way, the three-dimensional camera is enabled to: 1) capture image information over a wide field of view, and 2) enhance the native accuracy and resolution of the camera device. Mechanism 10 is illustrated in two positions. In a first position 12, the 3-D camera 21 is directed to a field of view as illustrated by line 25. In a second position 14, the camera 21 is positioned such that the field of view is illustrated by line 27. In this way, a single 3-D camera is able to have an extended field of view.

The mechanism generally comprises a base 17 that also may act as a housing for electronics and support mechanisms. The base 17 connects to a directable structure 19. The directable structure may be directed in larger-scale movements by actuators or motors into a plurality of positions, enabling the camera 21 to be aimed at different portions of the target. Once the 3-D camera 21 is directed toward a particular field of view portion, then smaller-scale adjustments may be made to directable structure 19 to enable a fine positioning of the camera for increasing pixel resolution. In this way, a single mechanical structure 10 may be used for increasing the field of view for 3-D camera, as well as enhancing pixel resolution and image quality.

Referring now to FIG. 2, a block diagram 50 of a mechanism for directing a three-dimensional camera system is illustrated. The mechanism has a processor 52 which is typically contained within a housing. In one example, the housing also acts as a base for the directable structure 54. The directable structure may be adjusted over two or more axis for precisely and particularly positioning a 3-D camera 56. The directable structure has a course control 61 to facilitate large-scale movement so that the 3-D camera 56 may be directed to different portions of a target. In this way, the limited field of view of a typical 3-D camera may be greatly expanded. By expanding a camera's field of view, a single camera may be used to image a large area instead of using of a complex multi-camera system.

Once the camera is directed to a particular portion of the target, a fine control 63 is used to make small adjustments to the directable structure 54 so that the camera's limited pixel resolution may be enhanced. This fine-resolution enhancement process may be referred to as a dithering process, which enables a relatively low resolution camera to increase its effective resolution. More particularly, multiple images are taken of an area of the target, with each image taken slightly offset from the previous image. The offset is adjusted so that the images are all within the distance of a single pixel area. The multiple images are then algorithmically processed to enhance the effective resolution of the 3-D camera.

Importantly, the mechanism 50 has a single directable structure that allows both large-scale movement for enhanced field of view, as well as fine-scale movement for enhanced pixel resolution. This same mechanical structure performs both large-scale movements for increasing the field of view, as well as smaller-scale movements for enhancing pixel resolution and image quality. Since mechanism 50 handles both coarse and fine motion, both motions are positioned to the same high level of accuracy. However, it will be appreciated that in some constructions the coarse adjustment may operate at a different level of accuracy as compared to the fine adjustment.

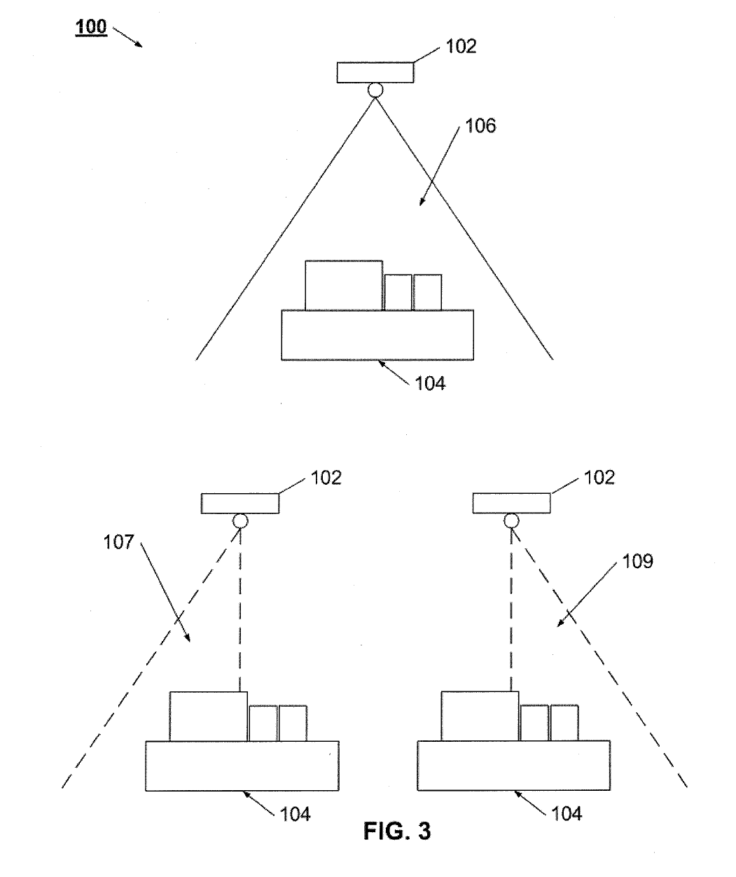

Referring now to FIG. 3, a system for measuring the volume of freight 100 is illustrated. System 100 has a directable camera mechanism 102. Directable mechanism 102 is like the directable mechanism 10 described with reference to FIG. 1. The directable mechanism 102 is useful for taking images of a target stack of freight 104. Typically, the directable mechanism 102 will be mounted about 15 to 18 feet above the freight 104. In this way, the 3-D camera is able to obtain a sufficiently wide field of view 106. However, the typical 3-D camera is not able to capture the entire field of view 106 in a single image. Accordingly, the camera system 102 uses its directable structure to first capture a field of view 107, and then the camera is repositioned and redirected to capture a second field of view 109. In this way, a single 3-D camera is able to have a sufficiently wide field of view. It will be appreciated that although field of view 106 has been shown divided into two portions (107 and 109), that more portions may be used. In this way, a single 3-D camera may have a highly expandable field of view.

At each field of view portion 107 and 109, the directable structure is finely adjusted to enhance pixel resolution. More particularly, the directable structure uses a course correcting structure to position the 3-D camera into a portion of the field of view, and once the camera is positioned for that field of view, an image is taken, and then one or more fine adjustments are made in the directable structure to position the camera so that pixel resolution may be increased.

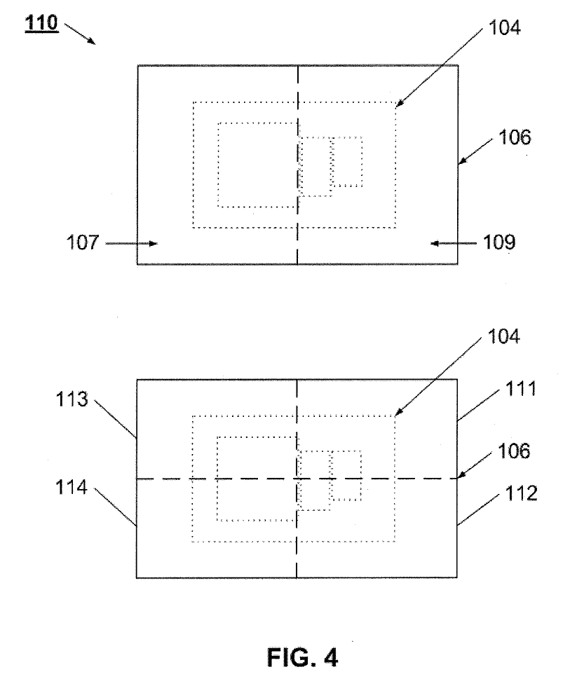

Referring now to FIG. 4, a top view of freight 104 is illustrated. Illustration 110 shows that the overall field of view 106 is divided into two field of view portions, 107 and 109, as more fully described with reference to FIG. 3. In this way, the directable structure directs the 3-D camera first to portion 107 and takes multiple images, and then moves the directable structure so that the 3-D camera is directed to the field of view portion 109, and then again uses its fine control to take multiple images. Using these multiple slightly offset images of the same portion allows for algorithmically enhancing pixel resolution. In another example, the freight 104 is portioned into more field of view portions, such as field of view 111, 112, 113, and 114. In this way, the camera is directed towards a field of view portion where multiple images are taken, and then the camera is directed to the next field of view portion. It will be appreciated that there may be some overlap between the field of view portions to accommodate stitching or weaving the images together. Although field of view illustration 110 shows the target area portion into either a 2 or a 4 field of view portion arrangement, it will be appreciated that other numbers or portions may be used according to the specific camera used, the distance between the camera and the target, and the overall field of view required for the particular application.

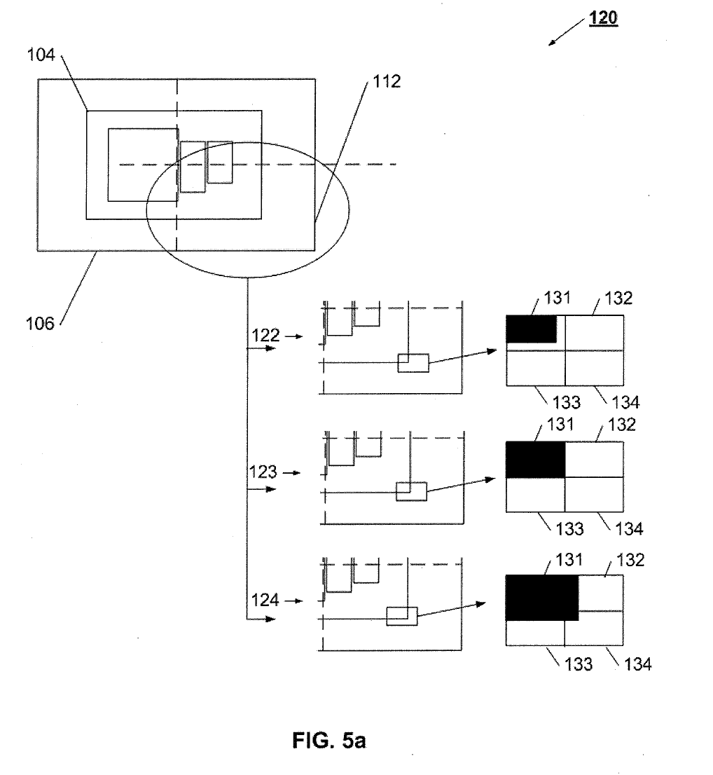

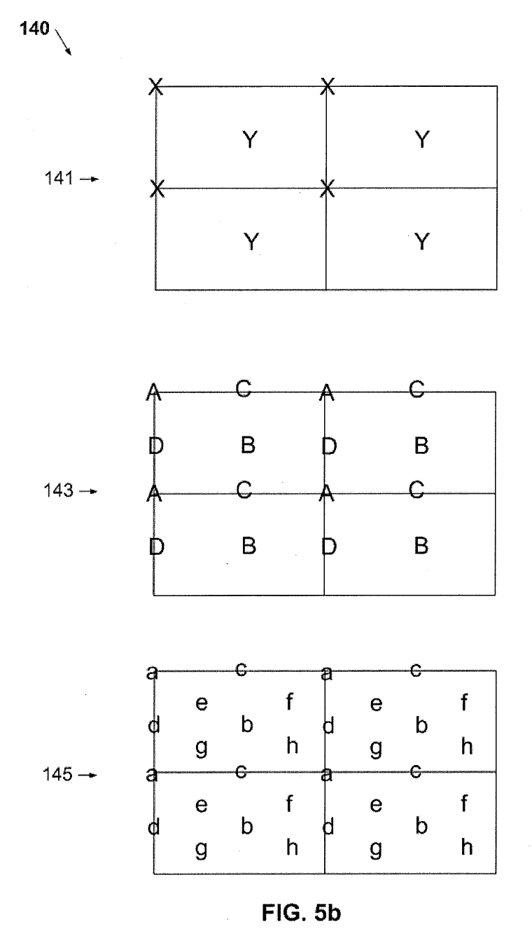

Referring now to FIG. 5a, the field of view portion 112 that was described with reference to FIG. 4 is more fully described. Field of view portion 112 is one of four portions that comprise the overall field of view 106 for imaging the freight stack 104. When the directable structure has aimed the camera toward view portion 112, the camera takes multiple images of the freight 104, with each image being slightly offset from the previous images. For example, fine adjustment system 120 shows that three images are taken while the camera is directed to field a view 112. Each image is illustrated with 4 virtual pixels (131-134) and their relationship with the corner of a box of freight. A first image 122 shows that the corner of the box is reflected back into pixel 131, and takes up approximately 80% of the pixel area. The sensor will report a data value for this pixel that is dependent of the collected energy. The collected energy is evaluated by the camera's circuitry to provide image and distance data. The position of the box does not cause pixels 132, 133, or 134 to change their collected energy. The directable structure is finely adjusted and a second image 123 is taken. At the second image, the corner of the box completely fills pixel 131, which will cause a different data value to be generated, but still does not affect the other adjacent pixels. A third image is taken after the directable structure is finely moved into a third position. In this position, pixel 131 remains fully utilized, but the box corner is now filling about 15% of pixels 132 and 133, and about 5% of pixel 134. In this way, each pixel will generate a different data value according to each pixel's collected energy, which will affect the distance value that is calculated by the camera. The processes to report a distance as used by the 3-D camera are well known, and will not be described in detail.

This differing pixel data may then algorithmically be processed to more accurately defined the edge or corner of the freight box, and the associated distances. Although three images are illustrated, it will be appreciated that more or fewer images may be taken. It will also be understood that the number of images taken will be dependent on the accuracy needed for the volumetric calculations, as well as the distance from the camera to the target freight. For example, the further away the camera is from the freight, the more pictures that should be taken to enhance resolution, due to the larger error introduced at longer distances.

Referring to FIG. 5b, other examples 140 of fine-camera movement are illustrated. FIG. 5b shows four virtual pixels for a volume measuring system having a directable structure as previously described. In pixel-set 141, the directable structure first positions the 3-D camera so that an image is take at position “X”, and then the directable structure is finely moved so that a second image is taken at position “Y”. The differences in the two images may them be used in dithering process for more accurately defining the dimensions and volume of the target. It will be appreciated that the dithering process is well understood, and will not be describe in detail. In pixel-set 142, the directable structure first positions the 3-D camera so that an image is take at position “A”, and the them the directable structure is finely moved so that three other images are taken in succession at positions “B”, “C”, and “D”. It will be appreciated that the images may be taken in any order. The differences among the four images may them be used in dithering process for more accurately defining the dimensions and volume of the target. In pixel-set 143, the directable structure first positions the 3-D camera so that an image is take at position “a”, and the them the directable structure is finely moved so that seven other images are taken in succession at positions “b” through “h”, respectively. It will be appreciated that the images may be taken in any order. The differences among the eight images may them be used in dithering process for more accurately defining the dimensions and volume of the target. It will be understood that more images may be taken, but there is a decreasing return on the improvement to resolution as the number is increased beyond 16 or so.

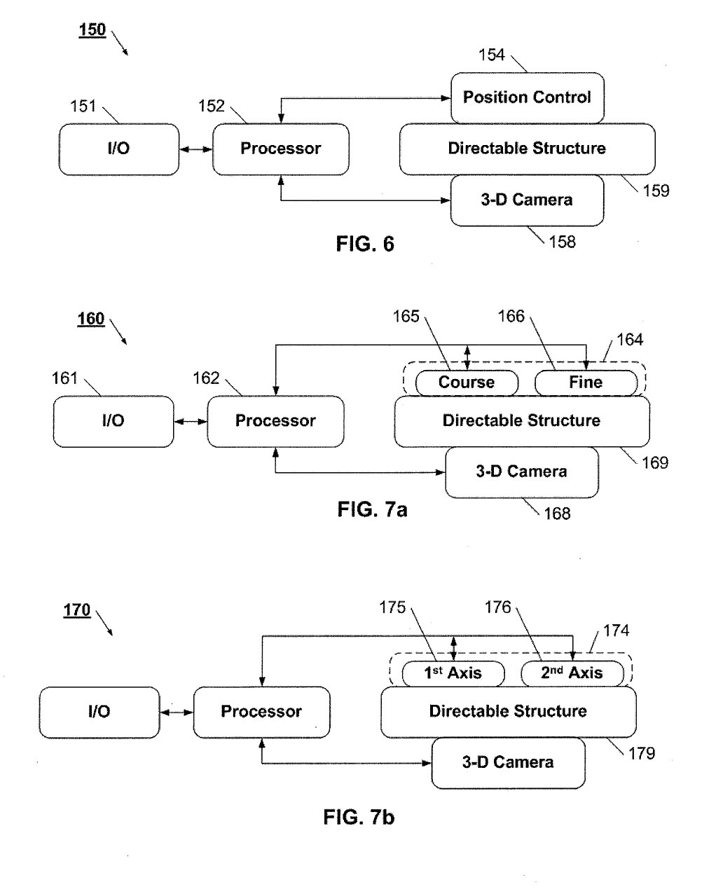

Referring now to FIG. 6, a block diagram 150 of a mechanism for directing a 3-D camera is illustrated. Diagram 150 shows that a processor 152 receives input from a user 151 as well as transmits status and result information to the user. The processor 152 is used to control a position control system 154. The position control system 154 may include motors, actuators, feedback systems, and other electronic and mechanical devices known for accurate position control. The position control is coupled to a directable structure 159, on which a 3-D camera 158 is mounted. In this way, movements directed by the position control effect the specific position of the directable structure, thereby directing a 3-D camera to specific portions of the target. Importantly, position control 154 has both the structure and processes to coarsely position the 3-D camera to enhance and enlarge the field of view for the 3-D camera, as well as a fine control for making fine adjustments to the directable structure for the purpose of enhancing the camera's native pixel resolution.

In some cases, position control may be common for both coarse and fine control as illustrated in FIG. 6. In other cases, as illustrated in block diagram 160 of FIG. 7a, the directable structure 169 may have separate electronic or mechanical structures for doing the course adjustment 165 and the fine adjustment 164. In this way the position control 166 has functionality divided between two different position control systems. System 160 has a processor 162 which has an input output system 161. The processor controls both the course 165 control and the fine 164 control for positioning the directable structure 169. The directable structure is used to position the 3-D camera 168.

FIG. 7b shows an alternative block diagram 170 where a processor has an input output system as previously discussed. The processor controls a position control system 174 that positions the directable structure 179. This in turn is used to position a 3-D camera. In diagram 170, the position control 174 has a first axis control 175 and a second axis control 174. Each axis may be both coarsely and finely adjusted under control of processor 172. For example, processor 172 may direct the first axis control 175 to a particular x-axis position and concurrently instruct the second axis control 174 to a specific y-axis position. Once the camera is set to a proper course adjustment for the desired field of view portion, then the camera control system 172 may make fine adjustments to either or both of the axis controllers 175 and 174 to make fine adjustments for increasing the camera's native pixel resolution. It will be appreciated that other mechanical structures may be used to obtain a similar coarse and fine adjustment of a 3-D camera.

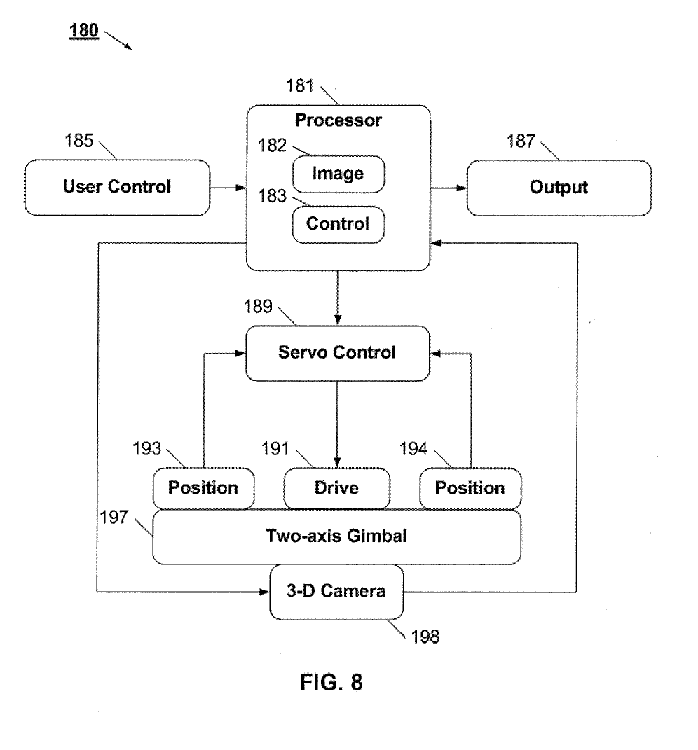

Referring now to FIG. 8, a more detailed block diagram 180 is illustrated for a mechanical structure for directing a 3-D camera. A processor 181 has both image management functionality 182 and position control functionality 183. Although processor 181 is illustrated having both image 182 and control 183 functions, it will be appreciated that these functions may be handled by separate or multiple processors. The processor 181 accepts user input 185. For example, user control 185 may be useful for indicating when the target has been properly positioned, or for setting specific resolution requirements for the particular scan being performed. The processor 181 also has an output 187 for reporting image, result, and control information. For example, output 107 may include a communication of volume results, or transmit actual raw image information for further processing. The output also may include alarms and notifications upon system failure, or may include simple notification of when the volume scan is complete.

Processor 181 commands a servo control 189. The servo control is used to position one or more drive motors 191. It will also be appreciated that drive 191 may take other forms, such as actuators or other controlled movement systems. The drive is connected to a two-axis gimbal 197, which acts as a directable structure. The two-axis gimbal is coupled to a 3-D camera 198. The two-axis gimbal has an x-axis position sensor 193 and the y-axis position sensor 194. The position sensors 193 and 194 feed back their position information to the servo control 189, which uses the information to accurately and confidently position the two-axis gimbal.

In use, a target may first be positioned within the overall field of view area, and then user control 185 is used to instruct processor 181 that images are ready to be taken. The processor determines how many field of view portions will be used, and directs the servo control to position the two-axis gimbal so that the 3-D camera is directed at the first field of view portion. When the camera is positioned, a series of images are taken, each slightly offset from the previous image. In this way, multiple images are taken within the pixel error size, allowing for enhanced pixel resolution. The multiple images are communicated back to processor 181, where the processor applies dithering algorithms to the images, and determines a more accurate edge placement for the target device. It will be appreciated that processor 181 may be used for making these calculations, or that the images may be transmitted to a more powerful remote processor for further processing. Once all of the fine images have been taken at the first field of view portion, the server control directs the two-axis gimbal to the next field of view portion, where again multiple images are taken for increased resolution. After all of the field of view portions have been completed, then the processor 181 creates an output 187 that indicates that the target has been completely scanned.

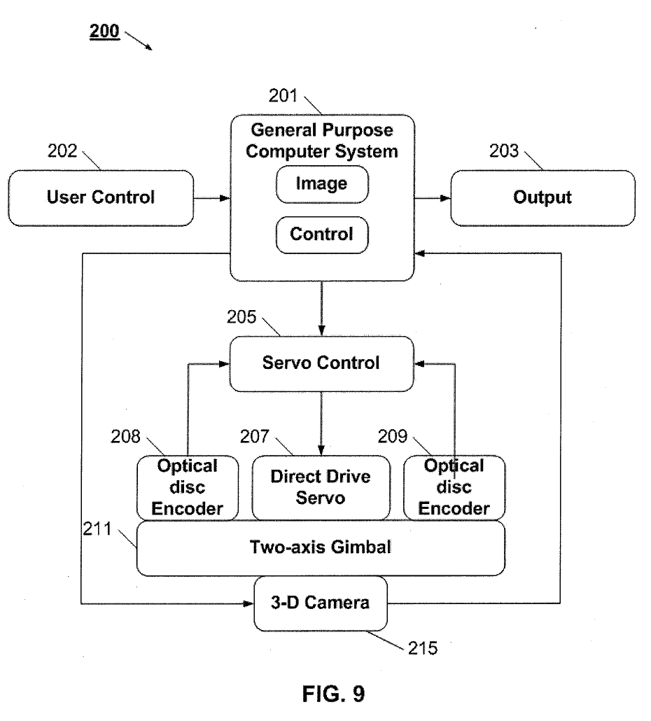

Referring to FIG. 9, a more specific system 200 is illustrated. System 200 has a general purpose computer system 201 that has image and control functionality. For example, the general purpose computer system may be a ruggedized IBM-compatible personal computer. In another example, the general purpose computer system may be a board level computer mounted in a housing. The housing may also act as the base for the directable structure and camera system. A user control 202 connects to the general purpose computer system 201, and various output systems 203 may be used. The general purpose computer system communicates to external devices, using either a parallel or serial bus. It will be appreciated that several known options exist for the communication paths between the general purpose computer system 201 and servo control 205. The servo control 205 controls one or more direct drive servomotors 207. The servo motor is used to position the two-axis gimbal 211, on which a 3-D camera 215 has been positioned. X-axis optical disk decoder 208 and y-axis optical disk decoder 209 are used to provide feedback to server control 205. In this way, highly accurate and repeatable position control is achieved.

The general purpose computer system 201 is also linked to the 3-D camera. In this way, the general purpose computer system may configure the image characteristics of the 3-D camera, as well as trigger its image taking function. The 3-D camera also communicates its image and result information to the general purpose computer system. For example, the 3-D camera may communicate raw image information, or some processing may be done within the 3-D camera Support circuitry itself.

In use, the general purpose computer system directs the servo control to direct the two-axis gimbal towards a first field of view portion. Once the camera is properly positioned in the first field of view portion, the general purpose computer system 201 directs the 3-D camera 215 to capture a first image. The general purpose computer system directs the server control to make fine adjustments to the two-axis gimbal, all within a single pixel error range. Each time the camera is moved to a new fine-position, the general purpose computer system 201 directs another image to be taken. In this way, multiple images are taken of the same field of view portion, with each image being slightly offset from the previous. In this way, the general purpose computer system may apply a dithering algorithm to the images for more actively locating edges o for the target. Accordingly, the 3-D camera resolution may be enhanced to give greater resolution and more accurate volume measurements. Once all the images have been taken at the first field of portion, the two-axis gimbal is coarsely moved to the next field of view portion.

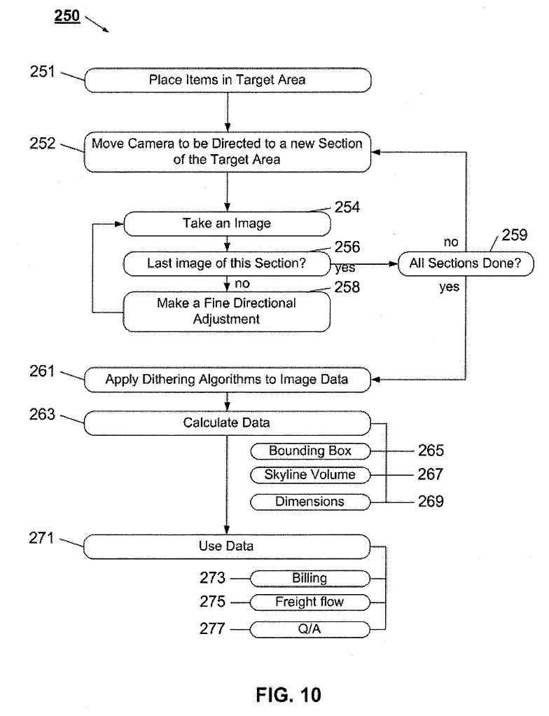

Referring now to FIG. 10, a flowchart 250 for a process for controlling the position of a 3-D camera is illustrated. Items are placed in a target area is illustrated at block 251. A directable structure is used to move the camera so that it is directed to a new portion of the target area as shown in block 252. A first image is taken as shown at block 254. If this is not the last image as queried in block 256, then the camera is moved in a fine directional adjustment as shown in block 258. This fine directional adjustment is within a pixel error range. Another image is taken as shown at block 254. In this way, multiple images are taken in the same field of view portion, with each image being slightly offset from each other image. Once all the images are taken within a particular field of view portion, then the camera makes a course move to the next field of view portion, and multiple images are again taken. Once all the portions are done as illustrated by 259, then the data is processed as shown at block 261. The multiple images for each portion are used to more accurately place edges for the target item. Also, the algorithmic processes may weave together multiple field of view portions for generating an overall accurate representation of the target item.

Results are then calculated as shown in box 263. For example volumetric data may be calculated by defining a binding box 265 or for finding a skyline volume information as shown at 267. In another example, dimension data may be presented as shown in block 269. These results may then be used as shown at block 271 for billing 273, defining freight flow within a warehouse 275, or for quality assurance purposes 277. It will be appreciated that other data may be defined and used according to application specific needs.

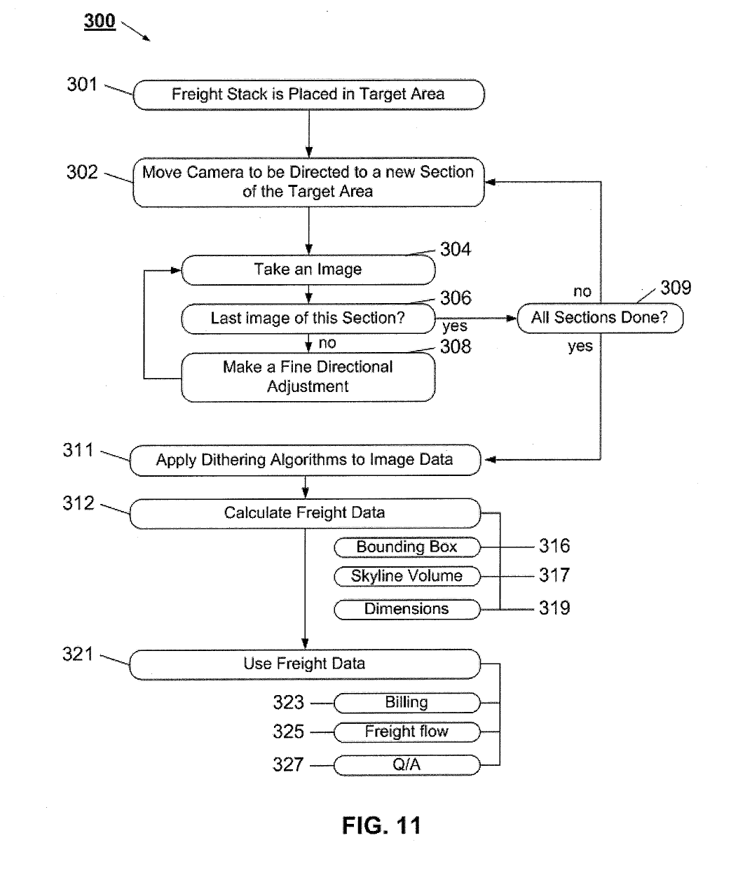

Referring to FIG. 11, a specific freight volume system 300 is illustrated. In flowchart 300, a freight stack is placed in the target area as shown in block 301. The directable camera structure is typically mounted about 15 to 18 feet above the freight stack, and a computer instructs the camera to be directed at a portion of the freight stack as shown in block 302. Multiple images are taken at each portion, as shown at blocks 304, 306, and 308. Each time the camera is adjusted to a new fine location, another image is taken, just slightly offset from the other images. After all the fine adjustment images are taken, the camera is directed to the next field of view portion. After all the field of view portions are done as shown in block 309, then image data is analyzed to more accurately find the freight edges, or to generate a weaved-together image of the freight stack as shown at block 311. The overall volume of the freight is calculated as shown in block 312. In one example a bounding box algorithm may be applied 316, or a skyline volume may be calculated as shown at block 317. It will be appreciated that other volumetric algorithms may be used. Further, dimension information may be provided as shown in block 319. The freight data is then used as shown at block 321 for billing, freight routing, or quality assurance purposes.

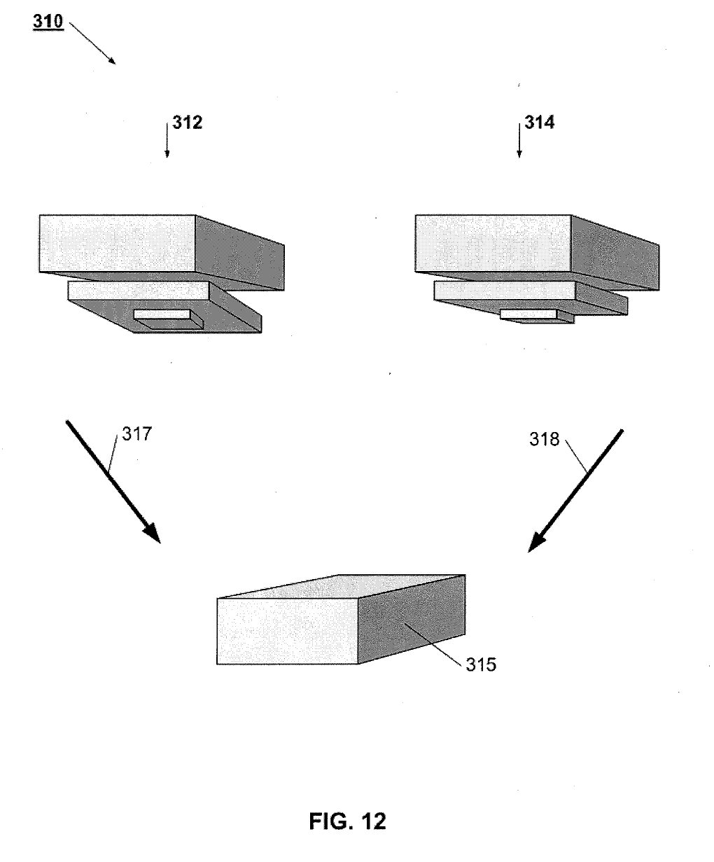

Referring to FIG. 12, an alternative mechanism 310 for directing a three dimensional camera system is illustrated. Mechanism 310 is similar to the directing mechanisms already discussed, so will not be described in detail. Generally, mechanism 310 has two directable structures 312 and 314 that are spaced apart to enable improved image coverage of the target area. As previously described, each directable structure has a 3-D camera, and may be coarsely positioned for expanding the field of view of the camera, and also may be finely set to enhance the pixel resolution of the camera. By using multiple spaced-apart positioning mechanisms, a more accurate representation of the freight or other target may be determined. It will be appreciated that each system may have its own processor, or that a central processor may control both directable structures. It will also be appreciated that more directable mechanisms may be added to further improve image accuracy.

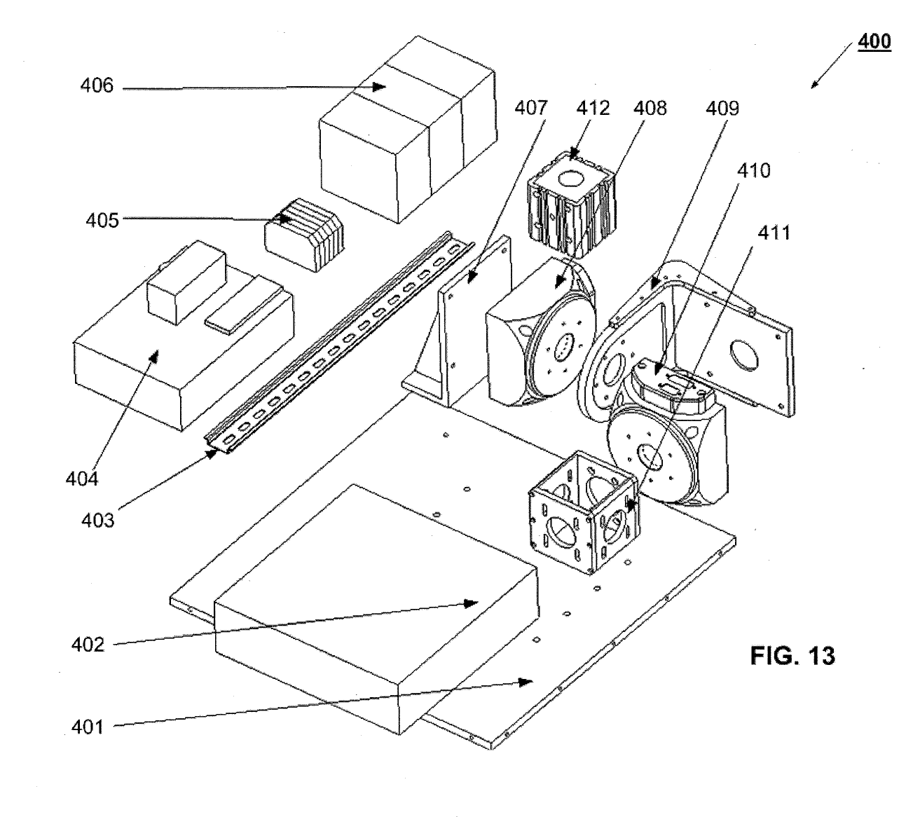

Referring now to FIG. 13, a more detailed exploded view of directable mechanism 400 is illustrated. Mechanism 400 will typically be mounted to the ceiling, but is illustrated with its mounting place at the bottom for ease of viewing and explanation. Mechanism has a base 401 that mounts to a support, such as a ceiling. A computer processor 402, for example a board-level personal computer, is mounted to the base 401. The computer 402 is typically capable of being networked to a remote system for obtaining instructions and for report data, results, and diagnostic information. In other cases, the computer 402 may be a stand-alone configuration. A power supply 406 and its power connection terminals 405 are also mounted on the base, and provide power for all the electrical and electronic devices in the mechanism 400.

A stationary bracket 407 is mounted on base 401, and a first axis direct drive motor 408 is fixedly attached to the bracket 407. A rotatable bracket 409 is connected to the first motor in a way so that motor 408 is able to rotate the rotatable bracket 409. The available angle of rotation is dependent on the specific construction used, but will typically allow for more than 90 but less than 180 degrees of rotation. It will be understood that the angle of available rotation will depend upon physical construction, and may be adjusted according to application needs. Direct drive motor 408 receives control signals from motor controller 404. Motor 408 also has an integrated or connected optical disk encoder for providing a feedback signal to the motor controller 404. In this way, the motor controller is able to accurately and repeatably put the rotatable bracket 409 into position.

A second axis direct drive motor 410 is mounted to the rotatable bracket 409 such that the first and second motors have an orthogonal relationship. A camera bracket 411 is attached to the second axis motor, and a 3-D camera 412 is mounted into the camera bracket 411. The second motor typically has a full range of rotation for the camera, although most applications require less than a 360 degree rotation. Direct drive motor 410 receives control signals from motor controller 404. Motor 410 also has an integrated or connected optical disk encoder for providing a feedback signal to the motor controller 404. In this way, the motor controller is able to accurately and repeatably put the camera bracket 411 into position.

In this construction, the bracket 407, first axis motor 408, rotating bracket 409, second axis motor 410, and the camera mount 411 act as a two axis gimbal for accurately and repeatably positioning the 3-D camera 412. Accordingly, responsive to an instruction from computer 402, the motor controller 404 is able to set the positions of both the first axis motor 408 and the second axis motor 410 so that the 3-D camera is precisely directed to a portion of the target field of view. After a first image is taken, the motor controller 404 (responsive to the computer 402), can finely direct the motors into other slightly offset positions so that other images may be taken. The computer 402 receives these images, and may transmit them to a remote device for further processing, or may process them locally. By applying a dithering process to these slightly offset images, the resolution of the 3-D camera may be enhanced over its native capability.

When all the images have been taken at the first field of view portion, responsive to an instruction from computer 402, the motor controller 404 is able to set the positions of both the first axis motor 408 and the second axis motor 410 so that the 3-D camera is precisely directed to a next portion of the target field of view. The process is continued until all the field of view portions have been completed.

Advantageously, the positioning mechanism 400 is easy to construct and calibrate, is accurate and repeatable, and allows a relatively inexpensive 3-D camera to have an expanded field of view and enhanced resolution. In this way, the expense and complexity of a multiple 3-D camera arrangement may be avoided.

By way of background, a three-dimensional camera is capable of providing, for every image pixel, image data as well as distance data. For example, the Swiss Ranger 4000 is a 3-D camera manufactured by Mesa Imaging AG of Zuerich, Switzerland. It has a resolution of 176×143 pixels, which at the expected distances, gives a resolution of about ¼ inch. It will be appreciated that higher resolution cameras may be used if more accuracy is needed. For each image frame, the Swiss Ranger 4000 provides a data set that has black-and-white image information for every pixel, as well as a distance value for every pixel. In this way, a fully three-dimensional data presentation may be obtained from a single camera frame.

Although the 3-D cameras may be constructed as the Swiss Ranger 4000, it will be appreciated that other 3-D camera systems may be used. For example, other optical 3-D systems are either available or soon will be available that provide 3-D frame information. In some cases, these alternative choices may provide color information, as well as higher resolution and higher accuracy distance numbers. Accordingly, these alternative devices may be adapted to applications requiring better images, more accurate volume calculations, or that have more complex freight geometries. It will be appreciated that the number, resolution, and position of the cameras may be adjusted according to application specific requirements.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A mechanism for directing a three-dimensional camera system at a target, comprising:
a base;
a directable structure operatively coupled to the base;
a 3-D camera attached to the directable structure;
a control system capable of positioning the directable structure in course movements and in fine movements.

2. The mechanism according to claim 1, where the directable structure comprises a two-axis gimbal.

3. The mechanism according to claim 1, where the directable structure comprises:
a first direct drive motor rotating on a first axis; and
a second direct drive motor rotating on a second axis.

4. The mechanism according to claim 1, where the directable structure comprises:
a first direct drive motor connected to the base and rotating a first bracket;
a second direct drive motor connected to the first bracket and rotating a second bracket; and
wherein the 3-D camera is connected to the second bracket.

5. The mechanism according to claim 1, where the directable structure comprises:
a first actuator providing a positioning movement on a first axis; and
a second actuator providing a positioning movement on a second axis.

6. The mechanism according to claim 1, where the directable structure comprises:
a first actuator connected to the base and positioning a first bracket;
a second actuator connected to the first bracket and positioning a second bracket; and
wherein the 3-D camera is connected to the second bracket.

7. The mechanism according to claim 1, wherein the control system comprises:
a processor; and
a motor controller in communication with the processor.

8. The mechanism according to claim 8, wherein the motor controller comprises an optical disk encoder in its feedback loop.

9. The mechanism according to claim 1, wherein the coarse movements are sized to direct the 3-D camera to a plurality of field-of-view portions to enable imaging a complete field of view for the target.

10. The mechanism according to claim 1, wherein the fine movements are sized to direct the 3-D camera to a plurality of dithering portions to enable imaging a target portion at a calculated pixel resolution that exceeds the native pixel resolution of the 3-D camera.

11. The mechanism according to claim 1, wherein the coarse movements and the fine movements are made with the same accuracy.

12. A method of measuring the volume of a target, comprising:
positioning a directable structure so that a 3-D camera is able to image a first portion of the target;
acquiring a first plurality of 3-D images, each image of the first set being offset from the other image(s) in the first set by less than a pixel distance, and the offset set by positioning the directable structure in fine movements;
positioning the directable structure so that the 3-D camera is able to image a second portion of the target;
acquiring a second plurality of 3-D images, each image in the second set being offset from the other image(s) in the second set by less than a pixel distance, and the offset set by positioning the directable structure in fine movements;
applying a dithering algorithm to the images to generate an enhanced pixel resolution that exceeds the native resolution of the 3-D camera; and
using the image data to calculate the volume of the target.

13. The method according to claim 12, wherein the first portion of the target and the second portion of the target overlap.

14. The method according to claim 12, wherein the target is stationary freight.

15. The method according to claim 12, wherein the target is moving freight.

16. The method according to claim 12, wherein each set of images has 2 images.

17. The method according to claim 12, wherein each set of images has 4 or 8 images.

18. The method according to claim 12, wherein positioning the directable structure comprises directing the movements of a plurality of direct drive motors.

19. A system for measuring the volume of target freight, comprising:
a base;
a first direct-drive motor fixed to the base and constructed to rotate a first bracket;
a second direct-drive motor fixed to the first bracket and constructed to rotate a second bracket;
a 3-D camera fixed to the second bracket;
a motor controller connected to the direct-drive motors, performing the steps of:
directing the motors to position the 3-D camera to a plurality of field of views, each field of view being only a portion of the target freight; and
directing the motors to position the 3-D camera, at each of the fields of view, to acquire a plurality of slightly offset images; and
a processor receiving image data from the 3-D camera, further performing the steps of:
dithering the plurality of images acquired at each respective field of view to generate enhanced image information that has a higher resolution than the native pixel resolution of the 3-D camera; and
using the enhanced image information to calculate the volume of the target freight.

20. The system according to claim 19 wherein there are more than two fields of view of the target freight, and for each field of view, more than two offset images are acquired.
